(19) United States
(12) Patent Application Publication
(10) Pub. No.: US 2011/0121528 A1
(43) Pub. Date: May 26, 2011

(54) HAND CART UNLOADING SYSTEM WITH ROTATABLE HANDLE

(76) Inventor: Gene Wyse, Wauseon, OH (US)

(21) Appl. No.: 12/971,805

(22) Filed: Dec. 17, 2010

Related U.S. Application Data
(63) Continuation of application No. 11/031,698, filed on Jan. 7, 2005, now abandoned.
Application No. 11/031,698 is a division of application No. 10/294,132, filed on Nov. 14, 2002, now abandoned.

(51) Int. Cl. B62B 1/04

(52) U.S. Cl. 280/47.27

(57) ABSTRACT

A system for assisting a user in unloading a hand cart is provided, including a rotatable handle for assisting the user in tilting the cart. The load is removed from the cart by tilting the cart forward, then pulling the cart out from under the tilted load. A spring-assisted handle mounted on the cart, which can be gripped and pulled by the user, assists the user in removing the load from the cart, in a simple and convenient manner.

### CROSS REFERENCE TO RELATED APPLICATIONS

This application is a continuation application of U.S. Ser. No. 11/031,698, filed Jan. 7, 2005, which was a divisional application of U.S. patent application Ser. No. 10/294,132, which was filed on Nov. 14, 2002. Application Ser. No. 11/031,698 is pending as of the filing date of the present application. U.S. patent application Ser. Nos. 10/294,132 and 11/031,698 are hereby incorporated by reference as if set forth in their entirety herein.

### BACKGROUND OF THE INVENTION

1. Field of the Invention

The present invention relates to a hand operated system for assisting in unloading a hand cart. More particularly, the present invention includes a hand cart with a rotatable handle for use in dislodging the load of a hand cart.

2. Summary of Related Art

Hand carts are well known in the material handling industry for loading and unloading material from trucks and trailers. Hands carts are used not only at truck loading docks, but also at retail establishments and other delivery points. Hand carts are also essential devices for moving loads within warehouses and production facilities. The primary construction of a hand cart includes two wheels on a single axle, two vertical frame members with cross frame members, a handle at the top of the frame, and a load engaging flange plate at the bottom of the frame.

In normal use of the hand cart, the user will typically tilt the cart toward himself, thus stabilizing the load on the cart for transport. A majority of hand carts do not have any system assisting the removal of the load from the cart. Typically, the user will tilt the cart forward, opposite the direction of tilt during normal use, and then attempt to slide the load off of the cart. This can involve simply using gravity to slide the load off of the cart. This can be dangerous, as it tends to leave the load in an unstable position during removal from the cart. Additionally, the user will also tend to alternately pull on the opposing handles of the cart, in an attempt to “step” the cart out from underneath the load.

Several assist systems for removal of load from hand carts are disclosed in the prior art. The hand carts of the prior art typically include either foot operated pedals operating mechanisms to displace the load, or hand operated handles engaging push plates to push the load off of the cart.

In the prior art, Brandenburg (U.S. Pat. No. 5,624,224) utilizes afoot-operated, pivotably mounted, spring-biased handle operating a mechanism to displace the load from the hand cart. Fixed, non-rotatable handles are also known in the art.

### SUMMARY OF THE INVENTION

According to the present invention, there is provided a hand cart with a handle, which can be pulled by the user to assist in unloading the hand cart. The handle is preferably mounted centrally on the hand cart, facing the user. The handle is preferably provided with a spring-assist mechanism to assist the user in tilting the cart, and to return the handle to a neutral position following the unloading of the cart.

An object of the present invention is to provide a hand cart with a hand operated handle to assist in the removal of the load from the cart.

Another object of the present invention is to provide a hand operated system for assisting the removal of the load from a hand cart that is mechanically simple and easy to use.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of the rear of an upright hand cart with the unloading system mounted on the cart;

FIG. 2 is a side perspective view of the hand cart showing the unloading handle in a partially depressed position; and

FIG. 3 is an exploded view of the structure of the rotatable unloading handle.

### DESCRIPTION OF THE PREFERRED EMBODIMENT

In FIG. 1, a hand cart 10 includes upright members 12 with a load bearing member 14, designed to be positioned beneath a load, and wheels 16 connected by an axle assembly 18. A fixed handle 20 is connected to the supports 12 near the top of the supports 12. The basic structure of hand carts is well known and variations are known within the filed, and are suitable for use with the present invention.

According to an embodiment of the present invention, a rotatable handle 22 is attached to the upright members 12. The rotatable handle 22 is attached to the members 12 at a point nearer the load bearing member 14 than the top of the members 12. The rotatable handle 22 preferably includes a U-shaped bar 24 and a spring mechanism to return the handle to its “rest” position. The ease of unloading the cart 10 is increased by locating the rotatable handle 22 nearer the bottom of the members 12, but placing the rotatable handle 22 too low increases the amount an operator must bend to grab the handle 22 and unload the cart. Therefore the location of the rotatable handle 22 must be balanced between ease of use and maximization of benefit of unloading the cart.

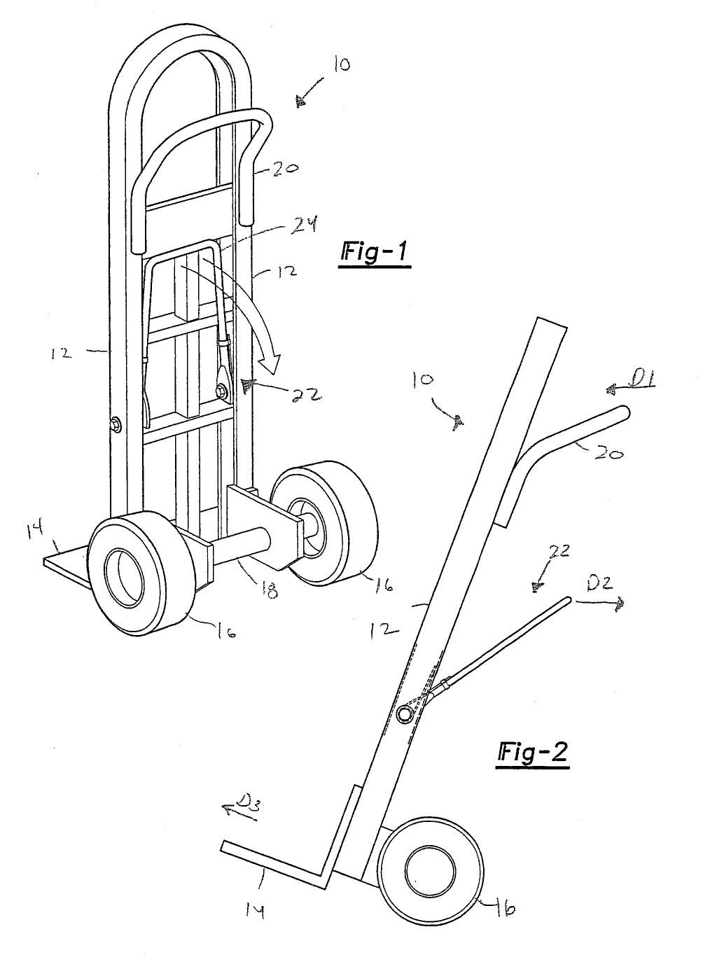

FIG. 2 illustrates the cart 10 in a partially reclined position, typical of a situation of transporting a load. The handle 22 is illustrated in a partially depressed position, illustrative of the situation wherein the rotatable handle 22 has been gripped by an operator.

To unload the cart 10, a user could place one hand on the handle 20, and the other hand on the rotatable handle 22. By pressing the handle 20 in the direction D1 and applying an opposing pulling motion on the rotatable handle 22 in the direction D2, the user will force the top of the cart 10 forward, causing the load to slide forward from the load bearing member 14 in the direction D3.

While a fixed handle could conceivably be used in place of rotatable handle 22, the use of the rotatable handle eases operation, and can decrease the physical force needed to unload the cart 10, thus reducing the strength needed by a user to unload the cart 10 safely.

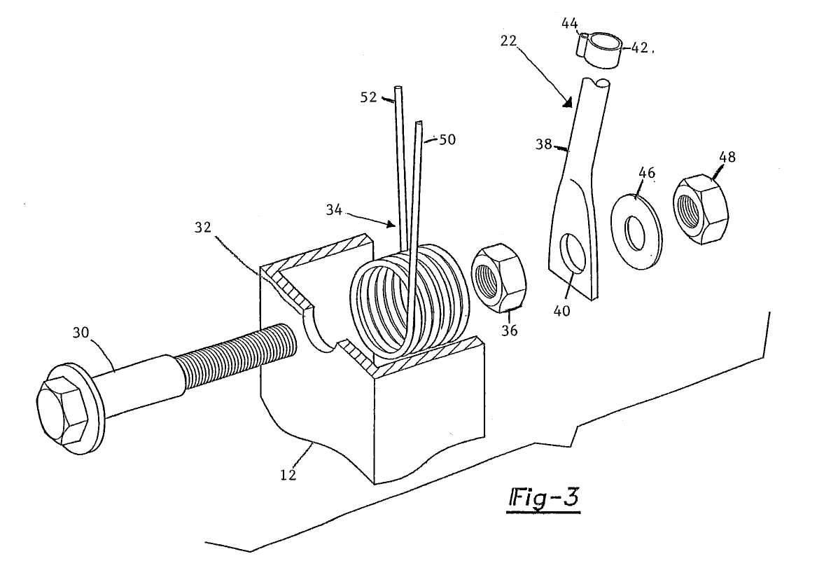

The rotatable handle 22 can be connected to the upright members 12 in any manner allowing rotation of the handle 22. A preferred method for connecting the rotatable handle 22 is shown in FIG. 3. In this embodiment a bolt 30 proceeds through a hole 32 in the upright member 12. At least a portion of the bolt 30 is threaded. A spring device, in this embodiment a coil spring, is positioned next to the hole 32, and the threaded bolt 30 extends through the coil of the spring 34. The spring 34 allows the rotatable handle 22 to return to its upright position when the handle is not being pulled. Additionally, the spring 34 assists the user in unloading the cart 10, by providing resistance against rotation of the handle 22. Increasing the tension of the spring 34 increases the resistance against the user rotating the handle 22, but assists the user in pulling the load bearing member 14 from under a load.

In at least one embodiment of the present invention, a nut is then placed on the threaded bolt adjacent the spring 34. On the opposing side of this nut is located an end 38 of the U-shaped member 24 of the rotatable handle 22. The threaded bolt 30 extends through a hole 40 in the end 38. Additionally, a mechanism can be provided to secure the spring 34 to the rotatable handle 22. In the embodiment shown, a circular ring 42 is placed around the U-shaped handle. The ring can have a channel 44 attached, through which an arm 52 of the spring 34 passes. This secures the spring 34 to the rotatable handle 22. Alternatively, the spring 34 can be connected to the handle 22 by any known means, including by merely positioning the arm of the spring 34 in such a manner that it rests securely against the arm 22. Alternatively, the spring can be secured to the handle by welding, or any other known method of connection. The opposing arm 50 of the spring 34 can be connected to the upright member 12 of the cart either by a firm connection, e.g. welding, or by resting against the member 12. As shown, the arm 50 of the spring 34 is positioned so that it is biased against an inside face of member 12. On the opposing side of the end 38 of the handle 22 is preferably placed a washer 46, followed by an end nut 48, to secure the spring mechanism in place.

While the embodiment shown pictures a coil spring, other spring mechanisms, as known in the art, can be used in conjunction with the present invention, for example a plate spring. Preferably, identical constructions of the connection shown in FIG. 3 are used on each of the members 12, so that spring mechanisms are in place on both sides of the rotatable handle 22. This provides the most balanced spring force to assist the user. Alternatively, it is possible for the spring mechanism to only be used on one side of the handle 12.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A hand cart for moving objects, said cart comprising:
a body comprising an upright structure with a load-bearing member extending from a lower portion of said upright structure;
first and second wheels rotatably connected to said body;
a rotatable handle to assist a user in unloading the cart, said rotatable handle being rotatably connected to the upright structure of the cart, forming an axis of rotation where said handle is connected to said upright structure;
said rotatable handle being configured to be operated by a user's hand; and
said rotatable handle comprising a spring assist mechanism,
wherein said rotatable handle is configured to be urged by said spring mechanism into substantial alignment with said upright structure of said body, and
said rotatable handle is configured so that a user can apply force to the upright structure with one hand and apply force, in a substantially opposing direction, to the rotatable handle with the other hand to dislodge the load bearing member from beneath a load, wherein said upright member pivots about said axis of rotation.

2. The handcart according to claim 1, wherein said spring assist mechanism comprises a coil spring.

3. The hand cart according to claim 1, wherein the rotatable handle comprises a U-shaped handle and at least one connecting mechanism to connect the rotatable handle to the cart.

4. The hand cart according to claim 3, wherein the upright structure comprises a pair of beams and structure to connect said beams, and wherein the at least one connecting mechanism comprises two connecting mechanisms and the U-shaped handle comprises two ends, and each end of the U-shaped handle is connected to a respective one of the beams of the upright structure by one of the connecting mechanisms.

5. The hand cart according to claim 4, wherein the U-shaped handle is disposed so that the ends of the handle point towards the load-bearing member.

6. The hand cart according to claim 5, wherein the connections between the U-shaped handle and the upright structure are nearer the bottom of the upright structure than the top of the upright structure.

7. The hand cart according to claim 3, wherein the connecting structure comprises a bolt and a nut.

8. The hand cart according to claim 7, wherein the connecting structure holds the spring assist mechanism in position relative to the upright structure and the rotatable handle.

9. The hand cart according to claim 1, further comprising a fixed handle in addition to the rotatable handle.

10. A hand cart for moving objects, said cart comprising:
a body comprising an upright structure and a load-bearing member, said upright structure comprising a pair of beams, and structure to connect said pair of beams;
first and second wheels, said first and second wheels being rotatably connected to said body;
a fixed handle to assist a user in moving the cart;
a rotatable U-shaped handle to assist a user in unloading the cart, said rotatable handle being rotatably connected to the upright structure of the cart;
a spring device disposed between the rotatable handle and the upright structure member, to assist in unloading the cart; and
a connecting mechanism comprising a bolt and nut, said connecting mechanism being disposed to connect the rotatable handle to the upright structure, and to hold the spring device relative to the upright structure and the rotatable handle; wherein
the spring device provides resistance against rotation of the rotatable handle upon application of force to the rotatable handle by a user; and
said rotatable handle is configured so that a user can apply force to the upright structure with one hand and apply force, in a substantially opposing direction, to the rotatable handle with the other hand to dislodge the load bearing member from beneath a load.

11. The handcart according to claim 10, wherein the spring device comprises a coil spring.

12. A method of dislodging a load from a load bearing member of a hand cart, wherein the cart comprises a body which comprises an upright structure with a load bearing member extending from a lower portion of the upright structure, first and second wheels rotatably connected to the body, a fixed handle and a rotatable handle to assist a user in unloading the cart, the rotatable handle being rotatably connected to the upright structure of the cart and being configured to be operated by a user's hand, the rotatable handle being located between the fixed handle and the load bearing member, the method comprising:
rotating the rotatably mounted handle and applying force to the rotatably mounted handle in a first direction; and
applying force to the fixed handle in a second direction generally opposite said first direction to tilt the cart to dislodge the load from the load bearing member, wherein the upright structure is displaced to a non-perpendicular position relative to the ground, and wherein the upright structure rotates about an axis of rotation.

13. The method according to claim 12, wherein a portion of the load bearing member loses contact with the ground.

14. The method according to claim 13, wherein the hand cart comprises wheels which are lifted from the ground while dislodging the load.

15. The method according to claim 15 wherein a portion of the load bearing member remains in contact with the ground while the load is being dislodged.

16. The method according to claim 15 wherein the hand cart has a top portion and a bottom portion, and the top portion of the cart is rotated substantially towards the load and the bottom portion of the cart is rotated substantially away from the load to dislodge the load from the hand cart.
